(19) United States
(12) Patent Application Publication
(10) Pub. No.: US 2010/0223442 A1
(43) Pub. Date: Sep. 2, 2010

(54) Computer system and data erasing method

(75) Inventors: Tetsuya YAMASHITA, Yokohama (JP); Daisuke SHINOHARA, Yokohama (JP); Yukinori SAKASHITA, Sagamihara (JP); Jun NAKAJIMA, Kawasaki (JP); Yasutaka KONO, Yokohama (JP)

Correspondence Address: Juan Carlos A. Marquez;c/o Stites & Harbison PLLC, 1199 North Fairfax Street, Suite 900, Alexandria, VA, 22314-1437, US

(73) Assignee: Hitachi, Ltd.

(21) Appl. No.: 12/385,734

(22) Filed: Apr. 17, 2009

(30) Foreign Application Priority Data
Feb. 27, 2009 (JP) 2009-046198

(51) Int. Cl. G06F 12/00; G06F 9/46; G06F 9/50

(52) U.S. Cl. 711/166; 718/104; 711/114; 711/E12.001

(57) ABSTRACT

Provided is a computer system for identifying all physical resources which have been allocated to logical units before to be subject to shredding and for performing shredding on the identified physical resources. All the physical resources related to the physical resources specified by a user to be subject to data erasing are selected using usage history for the storage system. Moreover, a shredding task for the selected physical resources is generated according to configuration information of the storage system and shredding is performed based on the generated task. Consequently, the data is completely erased.

### CLAIM OF PRIORITY

The present application claims priority from Japanese patent application JP 2009-46198 filed on Feb. 27, 2009, the content of which is hereby incorporated by reference into this application.

### BACKGROUND

This invention relates to a technique for completely erasing data stored in a storage system, and more particularly to a technique for erasing data stored in a resource used before.

A storage area network (SAN) in which one or more storage systems are coupled to one or more computers is known. In a case where a plurality of computers shares a large-scale storage system, the storage area network is very effective. A computer system coupled to the storage area network has great scalability because the storage system and the computers are easily added or removed. In recent years, the amount of data that the computers use has been increasing, and thus, the importance of the storage system has been increasing.

The storage system provides the computers with physical resources as a logical unit (LU). In addition, in a case where a user transfers data between the physical resources, the storage system switches the physical resources to be allocated to logical units without switching the logical units provided to the computers. More specifically, the storage system copies data to a physical resource to which an identifier is added from another physical resource to which an identifier is added. The storage system then erases the data in the physical resource of the copy source, and changes the identifier of the resource allocated to the logical unit. Accordingly, the data transfer is performed between the physical resources (see JP 2000-293317 A). This technique refers to as migration. Note that, the identifier of the physical resource is, for example, a serial number assigned to each physical resource by manufacturers.

Moreover, a disc array device is generally used for the storage system coupled to the SAN. The disc array device comprises a plurality of disc drives. The disc array device manages the plurality of disc drives as a redundant array of independent disks (RAID) group using the RAID technique. The RAID group includes more than one logical unit. The computer coupled to the SAN inputs/outputs data to the logical units. The disc array device records redundant data to the disc drives forming the RAID group when data is recorded in the logical units. Accordingly, the disc array device can restore data using the redundant data even in a case where a failure occurs in one of the disc drives.

In addition, the data in the logical unit subject to data erasing is overwritten with dummy data in order to erase data recorded in the disc drive. However, in a case where the number of overwriting data with the dummy data is only once, residual magnetism remains in the disc drive, so that the data may be restored by a third party. For that, proposed is a technique for completely removing the residual magnetism by overwriting the data with the dummy data at least three times (see JP 2007-011522 A). This technique refers to as shredding. The shredding completely removes the residual magnetism and prevents the data to be restored. In addition, data leak can be decreased.

### SUMMARY

In recent years, interest in security has been increasing. In order to completely erase the data recorded in the disc drive, the technique in which data is completely erased by overwriting the data with the dummy data for plural times is effective.

However, even though the data stored in the physical resource allocated to the logical unit which is currently used is completely erased, the residual magnetism may remain in the physical resource allocated to the logical unit which has been used before. For that, the data which has been erased can be restored using the residual magnetism and the stored data may leak out.

For example, even though the data stored in the logical unit that the user is currently using is erased, the residual magnetism of the data which is supposed to be erased may remain in the physical resource allocated to the logical unit which has been used before in a case where the migration is performed.

Therefore, in a case where the user intends to completely erase the data stored in the physical resource currently allocated to the logical unit, it is necessary to perform the shredding not only on the physical resource currently allocated to the logical unit but also on the physical resource of a migration source. However, the user or the administrator cannot identify the physical resource allocated to the logical unit which has been used before. Accordingly, the shredding cannot be properly performed on the physical resource of the migration source. More specifically, the user or the administrator cannot identify the physical resource which has been used before, which may have the residual magnetism of the data that is supposed to be erased, and which is currently used for other purpose. Moreover, timing for performing the shredding on the physical resource currently used for the purpose cannot be set.

Note that, the physical resource allocated to the logical unit which has been used before also cannot be identified using the techniques disclosed in JP 2000-293317 A and JP 2007-011522 A. In addition, the shredding also cannot be performed on the physical resource allocated to the logical unit which has been used before.

This invention is provided to solve the aforementioned problems. An object of this invention is to identify the physical resource (the physical resource of the migration source, for example) allocated to the logical unit which has been used before and to provide a computer system which is capable of performing the shredding on the identified physical resource.

A representative aspect of this invention is as follows. That is, there is provided a computer system comprising: a storage system which includes a storage device for providing a plurality of physical resources allocated to a plurality of logical units, a first processor and a first memory coupled to the first processor; and a management computer which manages the storage system, and which includes a second processor and a second memory coupled to the second processor, which stores first allocation information and second allocation information, the first allocation information including relation between the plurality of logical units and the plurality of physical resources that has been allocated to the plurality of logical units before, and the second allocation information including relation between the plurality of logical units and the plurality of physical resources that is currently allocated to the plurality of logical units. The management computer is configured to: identify a first physical resource which has been allocated before to a first logical unit specified for data erasing based on the first allocation information; and identify a second physical resource which is currently allocated to the first logical unit based on the second allocation information. The storage system is configured to: write data for data erasing into the identified first physical resource and the identified second physical resource.

According to an embodiment of this invention, the computer system is capable of selecting the physical resource subject to shredding based on task history of the logical unit, and performing the shredding on the selected physical resource.

### BRIEF DESCRIPTION OF THE DRAWINGS

The present invention can be appreciated by the description which follows in conjunction with the following figures, wherein:

FIG. 1 is a block diagram for showing a configuration of a computer system according to a first embodiment of this invention;

FIG. 2 is an explanation diagram for showing an example of a configuration of a task history table according to the first embodiment of this invention;

FIG. 3 is an explanation diagram for showing an example of a configuration of a task management table according to the first embodiment of this invention;

FIG. 4 is an explanation diagram for showing an example of a configuration of a configuration information management table according to the first embodiment of this invention;

FIG. 5 is a flowchart for showing a process of a logical unit task history search program according to the first embodiment of this invention;

FIG. 6 is a flowchart for showing a process of a physical resource usage obtaining program according to the first embodiment of this invention;

FIG. 7 is a flowchart for showing a process of a task execution program according to the first embodiment of this invention;

FIG. 8 is an explanation diagram for showing an example of a configuration of a task history table according to a second embodiment of this invention;

FIG. 9 is an explanation diagram for showing an example of a configuration of a task management table according to the second embodiment of this invention;

FIG. 10 is a block diagram for showing a configuration of a computer system according to a third embodiment of this invention;

FIG. 11 is an explanation diagram for showing an example of a configuration of a configuration information management table according to the third embodiment of this invention;

FIG. 12A is a flowchart for showing a physical resource usage obtaining program according to the third embodiment of this invention;

FIG. 12B is a flowchart for showing the physical resource usage obtaining program according to the third embodiment of this invention;

FIG. 13 is a flowchart for showing a task execution program according to the third embodiment of this invention; and

FIG. 14 is a flowchart for showing a path assignment (release) instruction program according to the third embodiment of this invention.

### DETAILED DESCRIPTION OF THE PREFERRED EMBODIMENTS

Hereinafter, a first to a third embodiments are described later with reference to the drawings. Note that, the each embodiment to be described below is one of the embodiments of this invention. This invention is not limited to the embodiments.

### Embodiment 1

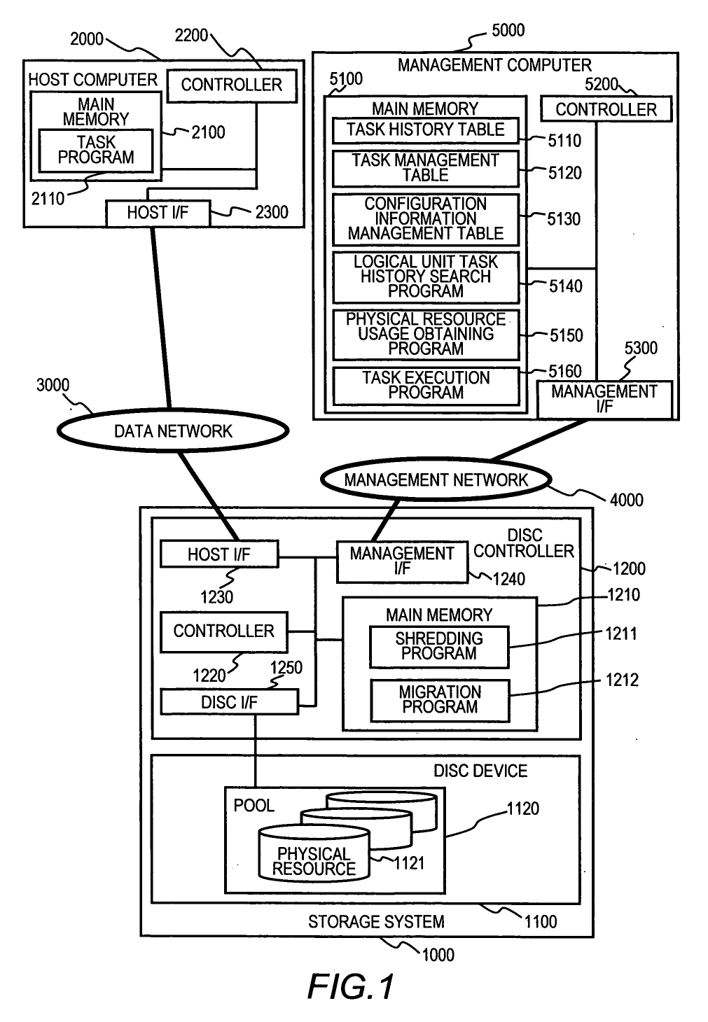

The first embodiment is described with reference to FIGS. 1 to 7.

<1-1 System Configuration>

FIG. 1 is a block diagram for showing a configuration of a computer system according to the first embodiment of this invention.

The computer system in the first embodiment comprises a storage system 1000, a host computer 2000 and a management computer 5000. The storage system 1000 and the host computer 2000 are coupled to each other via the data network 3000. In the first embodiment, the data network 3000 is a SAN. However, the data network 3000 may be an internet protocol (IP) network or other data communication network.

The storage system 1000 and the management computer 5000 are coupled via a management network 4000. In this embodiment, the management network 4000 is an IP network. However, the management network 4000 may be the SAN or other data communication network.

Note that, the data network 3000 and the management network 4000 may be the same network. Moreover, the host computer 2000 and the management computer 5000 may be the same computer. Note that, although FIG. 1 shows one storage system 1000, one host computer 2000 and one management computer 5000, the storage system, the host computer and the management computer may be provided more than one.

The storage system 1000 comprises a disc device 1100 and a disc controller 1200.

The disc device 1100 comprises a plurality of storage systems. The storage systems may be, for example, a hard disc drive, flash memory and the like.

The plurality of storage systems form a pool 1120 of more than one physical resource 1121. The pool 1120 forms more than one logical unit.

The logical unit is recognized by the host computer 2000 and is a logical resource for storing data.

The disc controller1200 comprises a main memory 1210, a controller 1220, a host I/F1230, a management I/F 1240 and a disc I/F 1250. In addition, the disc controller1200 controls processes of the storage system 1000.

The main memory 1210 stores a shredding program 1211 and a migration program 1212. The shredding program 1211 is a program for performing shredding on the logical unit or the physical resource. Here, shredding is a process for completely erasing residual magnetism of data remained in the disc drive by overwriting data with dummy data for plural times. The migration program 1212 is a program transferring data between a physical resource and another physical resource.

The controller 1220 comprises a processor which is not shown. The processor in the controller 1220 reads the shredding program 1211 and the migration program 1212 stored in the main memory 1210, and executes the each read program. The processor in the controller 1220 executes the processes of the shredding program 1211 and the migration program 1212. Hereinafter, it is explained that each program executes each process; however, the processor in the controller 1220 actually executes the each process according to the each program.

The host I/F 1230 is an interface coupled to the data network 3000, and transmits/receives data and controls instructions between the host computer 2000 and the storage system 1000. The management I/F 1240 is an interface coupled to the management network 4000, and transmits/receives data and controls instructions between the management computer 5000 and the storage system 1000. The disc I/F 1250 is an interface coupled to the disc device 1100, and transmits/receives data and controls instructions between the disc device 1100 and the disc controller 1200.

The host computer 2000 comprises a main memory 2100, a controller 2200 and a host I/F 2300. Note that, the host computer 2000 may comprise input/output devices (a key board, a display device and the like) which are not shown.

The main memory 2100 stores a task program 2110. The task program 2110 is a program which utilizes the logical unit in the storage system 1000. More specifically, the task program 2110 is a program such as database management system (DBMS), a file system or the like. In FIG. 1, although one task program 2110 is shown to simplify the explanation, the task program 2110 may be provided more than one.

The controller 2200 comprises a processor which is not shown. The processor in the controller 2200 reads the task program 2110 stored in the main memory 2100 and executes the read task program 2110. Hereinafter, it is explained that task program 2110 executes a process; however, the processor in the controller 2200 actually executes the process according to the task program 2110.

The host I/F 2300 is an interface coupled to the data network 3000, and transmits/receives data and controls instructions between the host computer 2000 and the storage system 1000.

The management computer 5000 comprises a main memory 5100, a controller 5200 and a management I/F 5300. Note that, the management computer 5000 may comprise input/output devices (a key board, a display device and the like) which are not shown.

The main memory 5100 stores a task history table 5110, a task management table 5120, a configuration information management table 5130, a logical unit task history search program 5140, a physical resource usage obtaining program 5150 and a task execution program 5160.

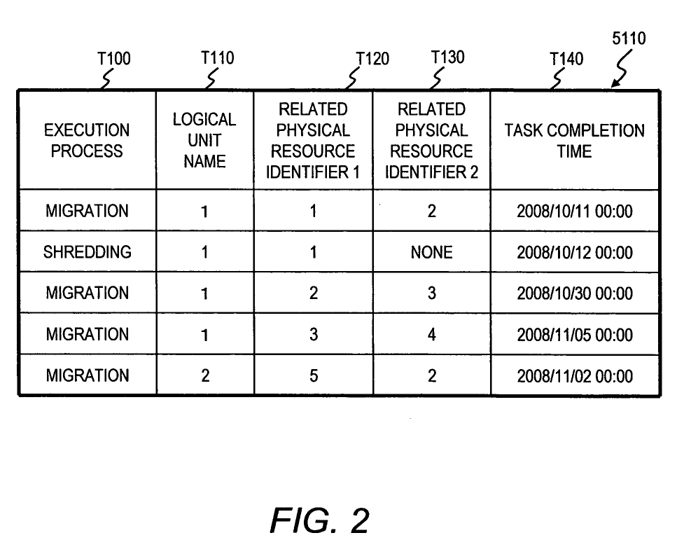

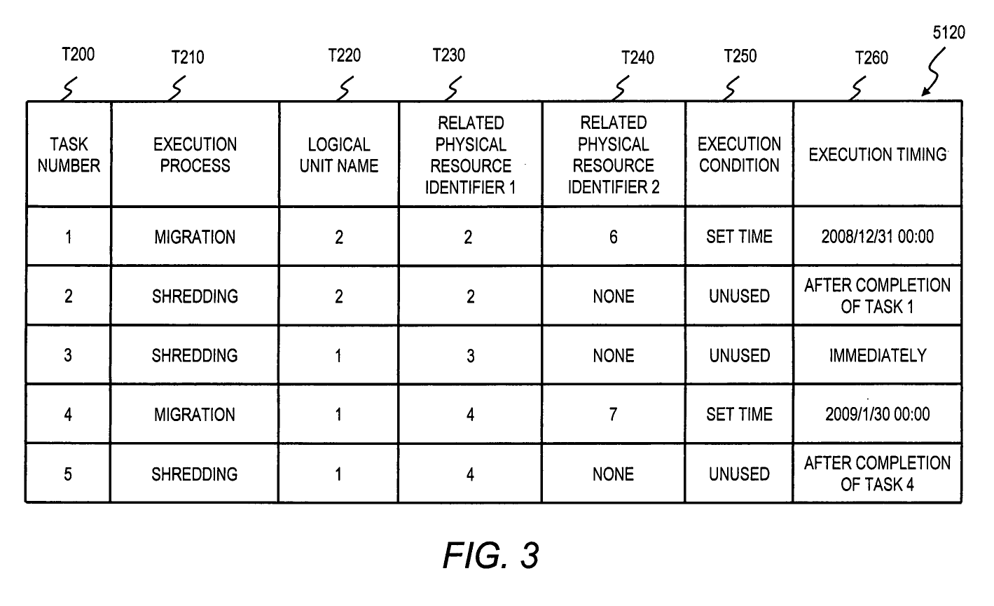

The task history table 5110 is a table for managing task history of tasks performed on the logical unit before. The detail on the task history table 5110 will be described later with reference to FIG. 2. The task management table 5120 is a table for managing tasks to be performed on the logical unit. The detail on the task management table 5120 will be described later with reference to FIG. 3. The configuration information management table 5130 is a table for managing usage of physical resources which are currently used.

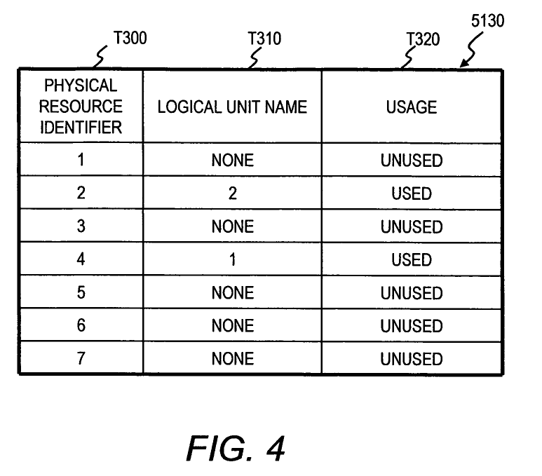

Here, the usage indicates information showing whether the physical resource is allocated to the logical unit to which the host computer 2000 or the storage system 1000 accesses. For example, the physical resource allocated to the logical unit to which the host computer 2000 accesses is shown as “used.” The physical resource allocated to the logical unit which is held by the storage system 1000 for a process such as migration, copy or the like is also shown as “used.” The physical resource currently not allocated to any of the logical units is shown as “unused.” Note that, in the first embodiment, although the configuration information management table 5130 is used for managing the usage of the physical resource, other table may be used. Here, the table is a table used for managing allocation of the physical resource to a plurality of host computers, for example. The detail on the configuration information management table 5130 will be described later with reference to FIG. 4.

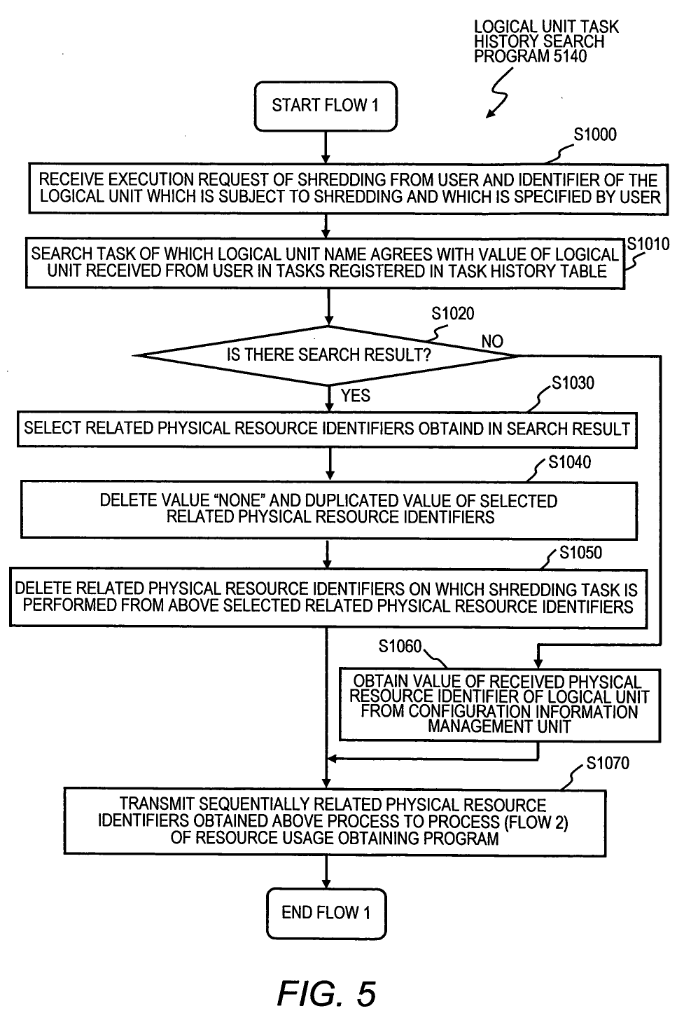

The logical unit task history search program 5140 refers to the task history table 5110 and selects an identifier of the physical resource which has been allocated to the logical unit specified by a user. The detail on the process of the logical unit task history search program 5140 will be described later with reference to FIG. 5.

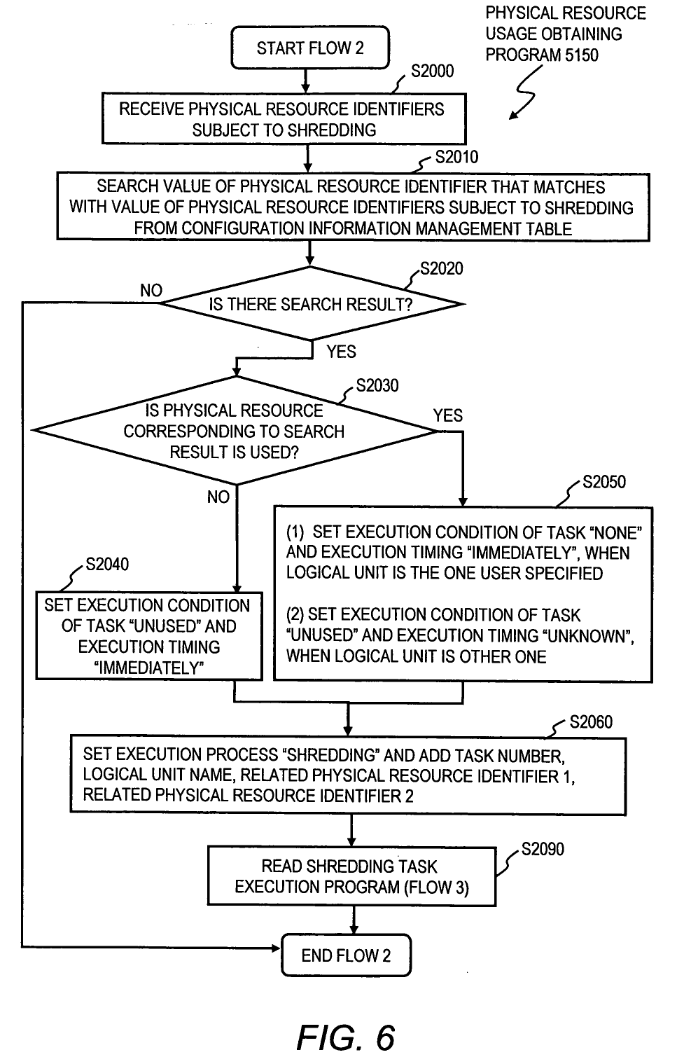

The physical resource usage obtaining program 5150 obtains the usage of the physical resource selected from the configuration information management table 5130 by the logical unit task history search program 5140. The physical resource usage obtaining program 5150 sets an execution condition and execution timing of the task for the physical resource selected according to the obtained usage. The physical resource usage obtaining program 5150 generates a task including the set execution condition and the execution timing and adds the generated task to the task management table 5120. Moreover, the physical resource usage obtaining program 5150 adjusts the execution condition and the execution timing of the task in the task management table 5120 as necessary. The detail on process of the execution condition and the execution timing will be described later with reference to FIG. 6.

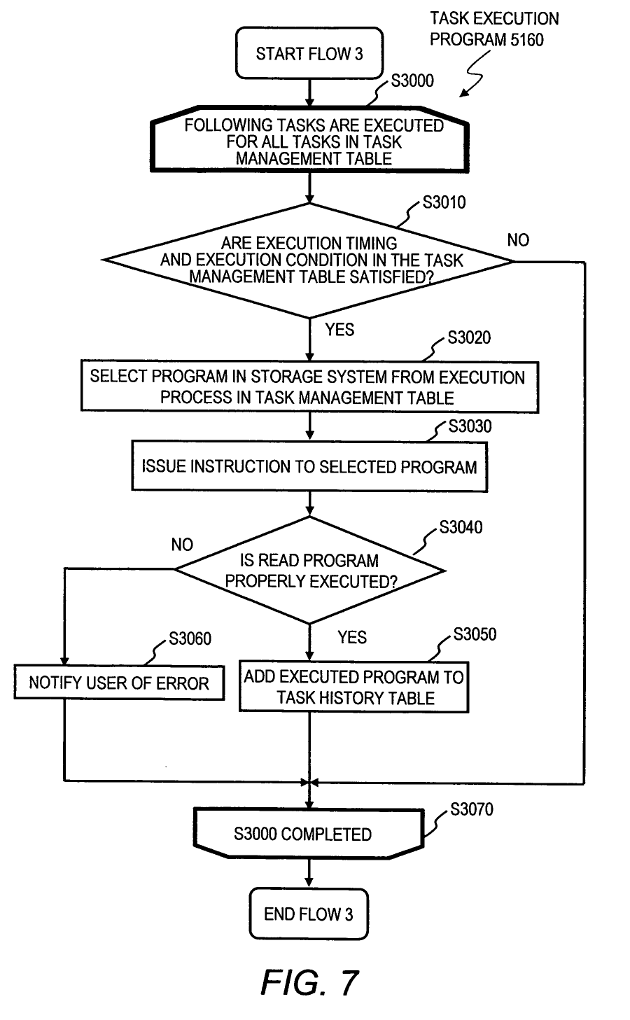

The task execution program 5160 refers to the task management table 5120 and performs the task such as shredding based on the execution condition and execution timing of the task. The task execution program 5160 may also perform a migration task. The detail on the process of the task execution program 5160 will be described later with reference to FIG. 7.

The controller 5200 comprises a processor which is not shown. The processor in the controller 5200 reads the logical unit task history search program 5140, the physical resource usage obtaining program 5150 and the task execution program 5160 stored in the main memory 5100, and executes each of the read programs. Hereinafter, it is explained that each program executes each process; however, the processor in the controller 5220 actually executes the each process according to the each program.

The management I/F 5300 is an interface coupled to the management network 4000, and transmits/receives data and controls instructions between the management computer 5000 and the storage system 1000.

Note that, although FIG. 1 shows the host computer 2000 and the management computer 5000 as physical computers, the host computer 2000 and the management computer 5000 may be virtual computers.

FIG. 2 is an explanation diagram for showing an example of a configuration of a task history table 5110 according to the first embodiment of this invention.

The task history table 5110 stores history of tasks performed on the logical unit in the storage system 1000 before. The task history table 5110 stores an execution process T100, a logical unit name T110, a related physical resource identifier 1 T120, a related physical resource identifier 2 T130 and a task completion time T140.

In the execution process T100, a name of the task (for example, “migration” and “shredding”) performed before is written. In the logical unit name T110, an identifier of the logical units is written. The identifier of the logical units is a logical unit number (LUN) in a case of a small computer system interface (SCSI), for example.

In the related physical resource identifier 1 T120 and the related physical resource identifier 2 T130, the identifier of each physical resource subject to the task written in the execution process T100 is written. The physical resource is a physical resource allocated to a logical unit. Note that, in a case where the execution process T100 is “migration,” an identifier of the physical resource of a migration source and an identifier of the physical resource of a migration destination are written in the related physical resource identifier 1 T120 and the related physical resource identifier 2 T130, respectively.

In addition, in a case where the execution process T100 is “shredding,” an identifier of the physical resource subject to shredding is written in the related physical resource identifier 1 T120 and information (for example, a character string “none”) indicating that there is no physical resource subject to shredding is written. In the task completion time T140, information on time at which the task written in the execution process T100 is completed is written.

Note that, the identifiers written in the logical unit name T110, the related physical resource identifier 1 T120 and the related physical resource identifier 2 T130 may be a character string or a symbol which uniquely identifies the logical unit or the physical resource other than the number. In addition, the task name written in the execution process T100 may be replaced with an appropriate character string, a number or a symbol indicating the task name. Moreover, the character string, “none,” written in the related physical resource identifier 2 T120 may be replaced with an appropriate number or a symbol which corresponds to “none.”

FIG. 3 is an explanation diagram for showing an example of a configuration of a task management table 5120 according to the first embodiment of this invention.

The task management table 5120 shows information on a task to be performed on the logical unit in the storage system 1000. The task management table 5120 stores a task number T200, an execution process T210, a logical unit name T220, a related physical resource identifier 1 T230, a related physical resource identifier 2 T240, an execution condition T250 and execution timing T260. In the task number T200, a task number to be performed is written.

The execution process T210, the logical unit name T220, the related physical resource identifier 1 T230 and the related physical resource identifier 2 T240 correspond to the execution process T100, the logical unit name T110, the related physical resource identifier 1 T120 and the related physical resource identifier 2 T130, respectively, in the task history table 5110 shown in FIG. 2.

In the execution condition T250, a condition for performing a task is written. In the execution timing T260, timing of performing a task is written. Here, the execution timing includes time, completion of other task, and notification of failure from other programs. To be more specific, for example, in the task entry “1,” when the time is at “set time,” which is “2008/12/31 00:00,” the task execution program 5160 instructs the migration program 1212 to perform “migration” from the physical resource “2” to the physical resource “6,” and then the migration program 1212 performs the migration.

In addition, for example, in the task entry “2,” after “migration” is performed from the physical resource “2” to the physical resource “6” which is “after the completion of the task 1,” and when the physical resource “2” is “unused” which means the resource is not allocated to a logical unit, the task execution program 5160 instructs the shredding program 1211 to perform “shredding” on the physical resource “2” and then the shredding program 5160 performs the shredding.

Note that, the identifiers written in the logical unit name T220, the related physical resource identifier 1 T230 and the related physical resource identifier 2 T240 may be a character string or a symbol which uniquely identifies the logical unit or the physical resource other than the number. In addition, the task name written in the execution process T210 may be replaced with an appropriate character string, a number or a symbol indicating the task name.

FIG. 4 is an explanation diagram for showing an example of a configuration of a configuration information management table 5130 according to the first embodiment of this invention.

The configuration information management table 5130 shows information on the usage of the physical resource in the storage system 1000. The configuration information management table 5130 stores a physical resource identifier T300, a logical unit name T310 and usage T320.

In the physical resource identifier T300, the identifier of the physical resource written in the task history table 5110 and the task management table 5120 is written. In a case where the physical resource is allocated to the logical unit, the identifier of the logical unit to which the physical resource is allocated is written in the logical unit name T310. In a case where the physical resource is not allocated to the logical unit, information (for example, a character string, “none”) indicating that the allocation is not made is written. In the usage T320, information (“used” or “unused”) indicating whether the physical resource shown in the physical resource identifier T300 is used by the storage system 1000 and the host computer 2000 is written.

Note that, the identifiers written in the physical resource identifier T300 and the logical unit name T310 may be a character string or a symbol which uniquely identifies the logical unit or the physical resource other than the number. The value of the usage T320 may be replaced with an appropriate character string, a number or a symbol indicating the current usage of the physical resources.

<1-2 Process>

FIG. 5 is a flowchart for showing a process of a logical unit task history search program 5140 according to the first embodiment of this invention.

First, the logical unit task history search program 5140 receives an execution request of shredding from a user and the identifier of the logical unit which is subject to shredding, and which is specified by the user (S 1000).

Subsequently, the logical unit task history search program 5140 refers to the task history table 5110 (see FIG. 2) and obtains the task which is executed before, and which is written in the task history table 5110 and the identifier of the logical unit subject to the task. After that, the logical unit task history search program 5140 judges whether the obtained identifier of the logical unit is the same as the identifier of the logical unit specified by the user (S1010, S1020).

In Step S1020, in a case where the obtained identifier of the logical unit is judged to be the same as the identifier of the logical unit specified by the user, the physical resource allocated to the logical unit of which the identifier is obtained may be the physical resource of the migration source corresponding to the logical unit specified by the user. Accordingly, the logical unit task history search program 5140 selects the identifier of the physical resource allocated to the logical unit specified by the user from the related physical resource identifier 1 T120 and the related physical resource identifier 2 T130 (S1030).

To be more specific, for example, in a case where the logical unit a “1” is specified for the shredding by the user, the logical unit task history search program 5140 selects the identifiers of the all physical resources which correspond to the logical unit a “1” from the task history table 5110 (see FIG. 2). For example, when physical resources which correspond to the logical unit “1” are selected in descending order of the entry, the values are “1”, “2”, “1”, “none”, “2” “3”, “3” and “4”.

Subsequently, in a case where a plurality of duplicated values are present, the logical unit task history search program 5140 deletes the duplicated values to keep only one of the duplicated values. Moreover, in a case where a value corresponding to a character string “none” or “none” is present, the value corresponding to the character string “none” or “none” is deleted (S1040). More specifically, for example, from the duplicated values such as “1” and “1”, “2” and “2” and “3” and “3”, each of the values “1”, “2” and “3” is deleted as well as “none”.

Next, the logical unit task history search program 5140 deletes the identifier of the physical resource on which the shredding has been performed from the selected identifiers of the physical resources (S1050). For example, since the shredding has been performed on the physical resource “1”, the logical unit task history search program 5140 deletes “1”. In other words, “2”, “3” and “4” are selected as the physical resources subject to shredding by the steps up to Step S1050.

After that, the logical unit task history search program 5140 transmits the identifiers of the physical resources obtained through the processes of Steps S1030 to S1050 to the physical resource usage obtaining program 5150 (S1070), and completes the process.

Meanwhile, in Step S1020, in a case where it is judged that the obtained identifier of the logical unit is not the same as the identifier of the logical unit specified by the user, the physical resource corresponding to the logical unit of which the identifier is obtained is not the physical resource of the migration source corresponding to the logical unit specified by the user. Accordingly, the logical unit task history search program 5140 obtains the identifier of the physical resource currently allocated to the logical unit specified by the user from the configuration information management table 5130 (see FIG. 4) (S1060). The process proceeds to Step S1070.

FIG. 6 is a flowchart for showing a process of a physical resource usage obtaining program 5150 according to the first embodiment of this invention.

The physical resource usage obtaining program 5150 receives the identifiers of the physical resource selected to be shredded transmitted from the logical unit task history search program 5140 (S2000). The identifiers of the physical resource selected to be shredded are “2”, “3” and “4”, for example.

Subsequently, the physical resource usage obtaining program 5150 refers to the configuration information management table 5130 (see FIG. 4), and judges whether the identifiers of the physical resources selected to be shredded are written in the configuration information management table 5130 (S2010, S2020).

In Step S2020, in a case where it is judged that the identifiers of the physical resources selected to be shredded are not written in the configuration information management table 5130, the physical resource usage obtaining program 5150 completes the process.

Meanwhile, in Step S2020, in a case where the identifiers of the physical resources selected to be shredded are judged to be written in the configuration information management table 5130, the physical resource usage obtaining program 5150 judges whether the physical resource selected to be shredded is allocated to the logical unit to which the host computer 2000 or the storage system 1000 accesses based on the usage T320 in the configuration information management table 5130 (S2030).

In Step S2030, in a case where it is judged that the physical resource selected to be shredded is not allocated to the logical unit to which the host computer 2000 or the storage system 1000 accesses, the physical resource usage obtaining program 5150 adds a new entry to the task management table 5120 (see FIG. 3). After that, the execution condition T250 and the execution timing T260 of the task of the shredding for the physical resource selected to be shredded is set to “unused” and “immediate”, respectively (S2040). Here, “immediate” means that the execution process “shredding” is performed immediately after the execution process is added to the task management table 5120.

Meanwhile, in Step S2030, in a case where the physical resource selected to be shredded is judged to be allocated to the logical unit to which the host computer 2000 or the storage system 1000 accesses, it is judged that the physical resource selected to be shredded is currently allocated to the logical unit of which the identifier is received from the user in Step S1000.

In a case where the selected physical resource subject to the shredding is judged to be currently allocated to the logical unit that the user specified in Step S1000 (which is a case (1) in Step S2050), the physical resource usage obtaining program 5150 adds an entry to the task management table 5120 (see FIG. 3). The physical resource usage obtaining program 5150 then sets the execution condition T250 and the execution timing T260 of the selected physical resource subject to the shredding to “none” and “immediately”, respectively. The execution condition “none” means that the execution condition is not set, and thus, a task can be executed as long as the execution timing is satisfied.

In a case where the selected physical resource subject to the shredding is judged to be currently allocated to the logical unit other than the logical unit specified by the user in Step S1000, (which is a case (2) in Step S2050), the physical resource usage obtaining program 5150 adds an entry to the task management table 5120 (see FIG. 3). The physical resource usage obtaining program 5150 then sets the execution condition T250 and the execution timing T260 of the selected physical resource subject to the shredding to “unused” and “unknown”, respectively (S2050).

For example, the physical resource “3” is unused among the physical resources “2”, “3” and “4” selected to be shredded according to the configuration information management table 5130 shown in FIG. 4. The physical resource “4” is allocated to the logical unit specified by the user in Step S1000 to be shredded. The physical resource “2” is a logical unit other than the logical unit specified by the user in Step S1000 and allocated to the logical unit which is used by the host computer 2000 or the storage system 1000. Accordingly, shredding can be performed on the physical resources “3” and “4” but cannot be performed on the physical resource “2”. Therefore, the physical resource usage obtaining program 5150 sets the execution condition T250 and the execution timing T260 of the task of shredding for the physical resource “3” to “unused” and “immediately”, respectively. Moreover, the physical resource usage obtaining program 5150 sets the execution condition T250 and the execution timing T260 of the task of shredding for the physical resource “4” to “none” and “immediately”, respectively. Also, the physical resource usage obtaining program 5150 sets the execution condition T250 and the execution timing T260 of the task of shredding for the physical resource “2” to “unused” and “unknown”, respectively.

Subsequently, the physical resource usage obtaining program 5150 sets necessary values to each of new entries added to the task management table 5120 (see FIG. 3). In other words, a task number is set to the task number T200; “shredding” is set to the execution process T210; an identifier of the logical unit to which the corresponding physical resource is allocated is set to the logical unit name T220; an identifier of the corresponding physical resource is set to the related physical resource identifier 1 T230; a value “none” or a character string corresponding to “none” is set to the related physical resource identifier 2 T240 (S2060). Note that, the execution condition T250 and the execution timing T260 are set in Step S2040 and Step S2050.

More specifically, as shown in FIG. 3, for example, “shredding” to the execution process T210, “2” to the logical unit name T220, “2” to the related physical resource identifier 1 T230, “unused” to the execution condition T250 and “unknown” to execution timing T260 in the entry of task “2” are set.

Here, the task of migration is to be performed on the physical resource “2” as shown in the task “1” and the usage T320 is “used.”

However, when the task of migration started at the set time (2008/12/31 00:00) completes, the usage T320 of the physical resource “2” becomes “unused”. Therefore, the task of shredding for the physical resource “2” is executed after the task “1” is completed. In short, the execution timing of the task “2” is “after completion of task “1.”

Furthermore, when the task of migration from the physical resource “2” to the physical resource “6” is completed, the usage T320 of the physical resource “2” shown in FIG. 4 becomes “unused.” Accordingly, the physical resource usage obtaining program 5150 sets the execution timing of the task “2” shown in FIG. 3 to “immediately”. Note that, the same process as the task “2” applies to the task “5” of the physical resource “4” which is currently used.

In addition, as shown in FIG. 3, for example, “shredding” to the execution process T210, “1” to the logical unit name T220, “3” to the related physical resource identifier 1 T230, “unused” to the execution condition T250 and “immediately” to execution timing T260 in the entry of task “3” are set.

Lastly, the physical resource usage obtaining program 5150 reads the task execution program 5160 (S2090) and completes the process.

Note that, the physical resource usage obtaining program 5150 may correct the execution condition and the execution timing of the task of migration other than the execution condition and the execution timing of the task of shredding. For example, in a case where the execution timing of the execution process “migration” of the task “1” shown in FIG. 3 reaches to the set time (2008/12/31 00:00), the execution timing may be corrected to “immediately.”

FIG. 7 is a flowchart for showing a process of a task execution program 5160 according to the first embodiment of this invention. The task execution program 5160 is read and executed in Step S2090 in FIG. 6; however, the execution is performed every time the set time passes.

The task execution program 5160 executes a process from Step S3000 to Step S3070 for the each entry written in the task management table 5120 (see FIG. 3).

First, the task execution program 5160 judges whether the execution timing T260 and the execution condition T250 of a task of one entry are satisfied (S3010).

For example, the task execution program 5160 judges whether the execution timing T260 of the task is “immediately”. In a case where the execution timing T260 is “immediately”, the task execution program 5160 then judges whether the execution condition T250 is satisfied. In Step S3010, in a case where the execution timing T260 is “immediately” and the execution condition T250 is satisfied (which means the corresponding physical resource is “unused,” for example), the task written in the entry is immediately executed. The process proceeds to Step S3020.

Meanwhile, in Step S3010, in a case where it is judged that the execution timing T260 is not “immediately” or that the execution timing T260 is “immediately” but the execution condition T250 is not satisfied, the task written in the entry is not executed immediately. Therefore, the process is completed (S3070) and the process is repeated from the Step S3000 for the next entry.

Here, a case where the execution timing T260 is “immediately” and the execution condition T250 is “unused” in Step S3010 is mainly described; however, it is not limited to the above. The execution timing T260 may be time or a relation with other tasks. In addition, the execution condition T250 may be time other than the usage of the physical resources.

Subsequently, the task execution program 5160 obtains a task name (“shredding” or “migration”) from the execution process T210 in the task management table 5120. The task execution program 5160 selects a program (the shredding program 1211 or the migration program 1212) corresponding to the obtained task (S3020). Then, the task execution program 5160 issues an execution instruction to the selected program (S3030).

In a case where the task is “shredding,” the task execution program 5160 issues an execution instruction to the shredding program 1211. Moreover, the logical unit name which corresponds to the physical resource subject to shredding and/or the related physical resource identifier 1 is/are notified. Here, the shredding program 1211 executes the shredding process for the physical resource corresponding to the related physical resource identifier which corresponds to the notified logical unit name.

In a case where the task is “migration,” the logical unit name which corresponds to the physical resource subject to migration and/or the related physical resource identifier 1 and the related physical resource identifier 2 is/are notified to the migration program 1212. Here, the read migration program 1212 executes migration between the related physical resource identifier 1 and the related physical resource identifier 2 of the physical resource of the notified logical unit name.

Next, the task execution program 5160 judges whether the read program is properly executed (S3040). In Step S3040, in a case where the read program is judged to be properly executed, the task execution program 5160 registers the task which is completely executed in the task history table5110 (see FIG. 2) (S3050). The process proceeds to the next entry.

Note that, the task execution program 5160 may delete an entry corresponding to the task which is completely executed from the task management table 5120 (see FIG. 3) after Step S3050. Moreover, the task execution program 5160 may notify the physical resource usage obtaining program 5150 of the task which is completely executed. The physical resource usage obtaining program 5150 may delete an entry corresponding to the notified task from the task management table 5120 (see FIG. 3).

Meanwhile, in Step S3040, in a case where it is judged that the read program is not properly executed, the user is notified of an error (S3060). The process proceeds to the next entry.

The task execution program 5160 ends the process after the process from Step S3010 to Step S3060 is completed for all the entries registered in the task management table 5120 (S3070).

As described above, according to the first embodiment, the computer system can select the physical resources which have been allocated before in addition to the physical resource which is currently allocated to the logical unit specified by the user to be subject to shredding. Accordingly, the computer system can perform shredding on each of the selected physical resources. In addition, the current usage can be considered by setting the execution timing and the execution condition, and thus, shredding can be performed even on the physical resources which have been selected to be shredded.

With this, an administrator of the storage system can manage the storage system while ensuring high security without decreasing the usability.

### Second Embodiment

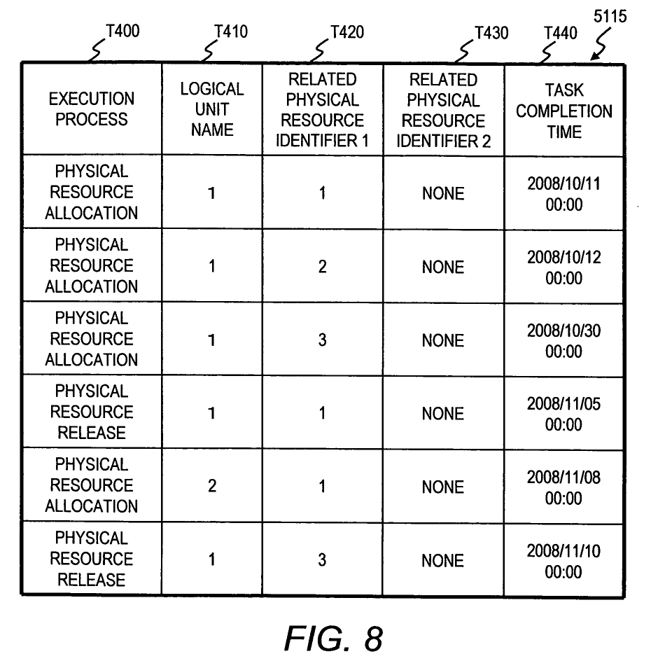

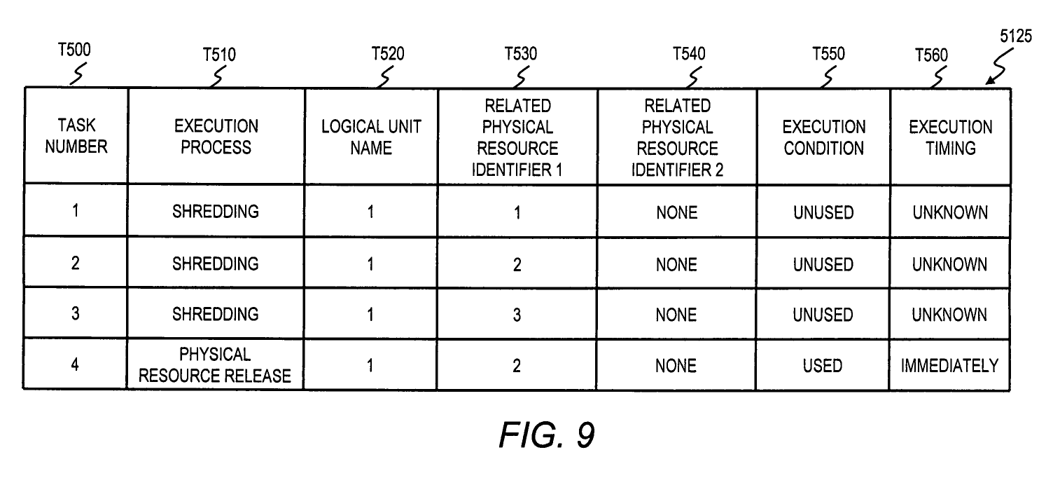

Next, a second embodiment of this invention is described with reference to FIGS. 8 and 9.

The computer system in the first embodiment completely deletes data stored in the physical resource allocated to the logical unit in the storage system using the shredding function of the storage system. A computer system according to the second embodiment completely deletes data in a case where a storage system has a function to allocate the physical resource (or a segment which is an area of the physical resource) of a disc device according to a request from a host computer.

Here, the function to allocate the physical resource of the disc device according to the request from the host computer is disclosed, for example, in JP 2003-015915A and is called as thin provisioning or allocation on use (AOU). According to the technique disclosed in JP 2003-015915A, although the host computer recognizes the capacity of a logical unit in a storage device is 10 GB, the storage system does not actually allocate capacity until the logical unit receives a write request or the like from the host computer.

The actual capacity of the logical unit is dynamically extended by the host computer receiving the request and allocating the physical resource. Therefore, the capacity of the logical unit, which the host computer recognizes may differ from the capacity actually allocated to the logical unit. Thus, in the storage system, the logical unit formed using the thin provisioning is called a virtual logical unit. In the second embodiment, the physical resource subject to shredding is a physical resource allocated to the virtual logical unit.

### <2-1 System Configuration>

The computer system in the second embodiment has the same configuration as the computer system in the first embodiment as shown in FIG. 1. However, a management computer 5000 in the second embodiment includes a task history table 5115 and a task management table 5125. A storage system 1000 in the second embodiment includes a program for allocating the logical unit to the physical resource according to an access request and releasing the allocated physical resource. “releasing the allocated physical resource” means unallocating the physical resource allocated to the logical unit.

FIG. 8 is an explanation diagram for showing an example of a configuration of a task history table 5115 according to the second embodiment of this invention.

The task history table 5115 includes an execution process T400, a logical unit name T410, a related physical resource identifier 1 T420, a related physical resource identifier 2 T430 and a task completion time T440. The items of the task history table 5115 and the task history table 5110 shown in FIG. 2 are the same.

However, in the execution process T400, “physical resource allocation” or “physical resource release” is written other than the tasks of “migration” and “shredding” shown in FIG. 2. Here, the physical resource allocation is an allocation process of physical resource using a capacity automatic extending method of the disc device. Moreover, the physical resource release is a process of releasing the physical resource allocated to the logical unit.

In a case where “physical resource allocation” or “physical resource release” is written in the execution process T400, a value of an identifier of the physical resource subject to “physical resource allocation” or “physical resource release” is written in the related physical resource identifier 1 T420, and a character string “none” is written in the related physical resource identifier 2 T430.

FIG. 9 is an explanation diagram for showing an example of a configuration of a task management table 5125 according to the second embodiment of this invention.

The task management table 5125 includes a task number T500, an execution process T510, a logical unit name T520, a related physical resource identifier 1 T530, a related physical resource identifier 2 T540, an execution condition T550 and an execution timing T560.

The items of the task management table 5125 and the task management table 5120 shown in FIG. 3 are the same.

However, in the execution process T510, “physical resource allocation” or “physical resource release” is written other than the tasks of “migration” and “shredding” shown in FIG. 2.

In a case where “physical resource allocation” or “physical resource release” is written in the execution process T510, a value of an identifier of the physical resource subject to “physical resource allocation” or “physical resource release” in the related physical resource identifier 1 T530, and a character string “none” is written in the related physical resource identifier 2 T540.

### <2-2 Process>

The process of the computer system according to the second embodiment is the same process as the first embodiment except the allocation and the release processes of the physical resources.

The process of a logical unit task history search program 5140 in the second embodiment is the same process as the logical unit task history search program 5140 in the first embodiment shown in FIG. 5.

The process of a physical resource usage obtaining program 5150 in the second embodiment is the same process as the physical resource usage obtaining program 5150 in the first embodiment shown in FIG. 6.

The process of a task execution program 5160 in the second embodiment is the same process as the task execution program 5160 in the first embodiment shown in FIG. 7. However, in Step S3020 to Step S3030 in FIG. 7, in a case where the physical resource allocation or the physical resource release is written in the execution process T510 of the task management table 5125, the task execution program 5160 issues an instruction to process the allocation or release of the physical resource provided in the storage system 1000 to the storage system 1000. The storage system 1000 which received the instruction executes the process of allocation or release of the physical resource using the program for allocating or releasing the physical resource to or from the logical unit.

As described above, according to the second embodiment, the computer system can select the physical resources which have been allocated before in addition to the physical resource which is currently allocated to the logical unit specified by the user to be subject to shredding. Accordingly, the computer system can perform shredding on each of the selected physical resources. In addition, the current usage can be considered by setting the execution timing and the execution condition, and thus, shredding can be performed even on the physical resources which have been selected to be shredded.

With this, an administrator of the storage system can manage the storage system while ensuring high security without decreasing the usability.

### Third Embodiment

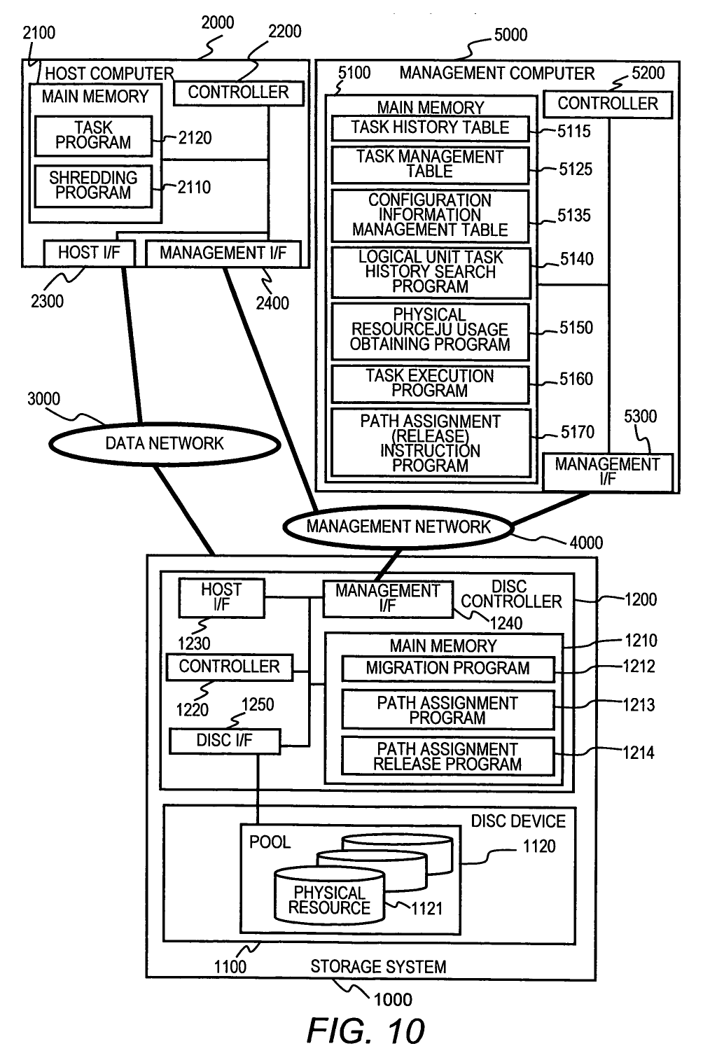

Next, a third embodiment of this invention is described with reference to FIGS. 10 to 14.

The computer system in the first and the second embodiments perform shredding on the physical resource using the function of shredding provided in the storage system 1000. Meanwhile, a computer system in the third embodiment performs shredding on a logical unit using a function of shredding provided in a host computer 2000. Here, in the third embodiment, the host computer 2000 can recognize the logical unit but cannot recognize the physical resource. Accordingly, shredding is performed on the logical unit and information stored in the physical resource allocated to the logical unit is deleted.

Moreover, in the third embodiment, the logical unit subject to shredding is same as that of the first embodiment but may be a virtual logical unit having a function (the thin provisioning or AOU) for allocating a segment according to an access request from the host computer to the logical unit as similar to the second embodiment.

### <3-1 System Configuration>

FIG. 10 is a block diagram for showing a configuration of a computer system according to the third embodiment of this invention.

The configuration of the computer system in the third embodiment is the same configuration as the computer system in the first embodiment shown in FIG. 1; however, the configuration differs as below.

A storage system 1000, the host computer 2000 and a management computer 5000 are coupled with each other through a management network 4000.

A main memory 1210 in the storage system 1000 does not store the shredding program 1211(see FIG. 1) but stores a path assignment program1213 and a path release program1214. Here, in the third embodiment, “path assignment to the host computer” means that the logical unit of the storage system 1000 is made recognizable to the host computer 2000. Moreover, “path assignment release” means that the logical unit of the storage system 1000 is made unrecognizable to the host computer 2000. In other words, the path assignment program1213 is a program for making the logical unit recognizable to the host computer. In contrast, the path release program1214 is a program for making the logical unit unrecognizable to the host computer.

The host computer 2000 comprises a management I/F 2400 coupled to the management network 4000. The management I/F 2400 is an interface coupled to the management network 4000 and transmits/receives data and controls instructions between the storage system 1000 and the management computer 5000.

The main memory 2100 in the host computer 2000 stores a shredding program 2120, which differs from the host computer 2000 in the first and the second embodiments.

A main memory 5100 in the management computer 5000 stores a path assignment (release) instruction program 5170.

The path assignment program12l3 and the path release program1214 may be stored not in the storage system 1000 but in other computer such as the management computer 5000.

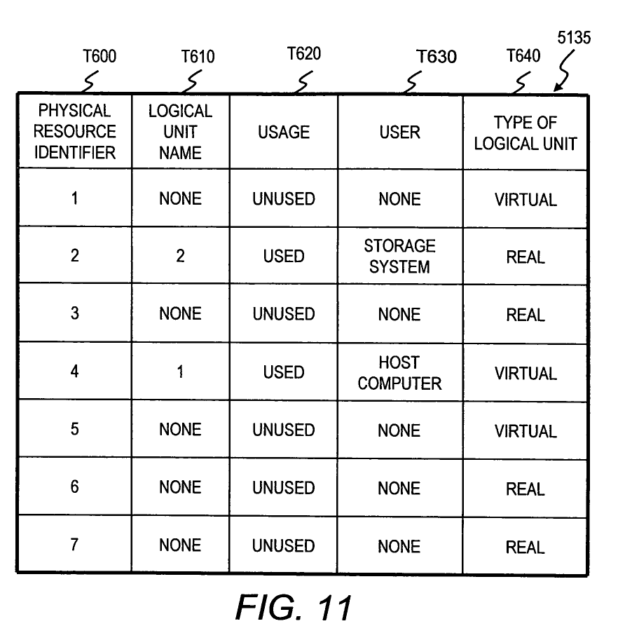

FIG. 11 is an explanation diagram for showing an example of a configuration of a configuration information management table 5135 according to the third embodiment of this invention.

The configuration information management table 5135 is information on usage for the physical resource of the storage system 1000. The configuration information management table 5135 includes a physical resource identifier T600, usage T620, a logical unit name T610, a user T630 and a logical unit type T640.

The physical resource identifier T600, the logical unit name T610 and the usage T620 in the configuration information management table 5135 are the same as the physical resource identifier T300, the logical unit name T310 and the usage T320 in the configuration information management table 5130, respectively in the first embodiment shown in FIG. 4.

Information on the user who is currently making an access to the logical unit is written in the user T630. For example, in a case where the storage system 1000 is holding the logical unit as a migration destination, the character string “storage system” is written as user information in the user T630. In a case where the host computer 2000 is writing data into the logical unit, the character string “host computer” is written as user information in the user T630. In a case where there is no user, the character string “none” is written as user information in the user T630.

In a case where the user is “storage system”, the path assignment to the host computer is released because the storage system is holding the logical unit as the migration destination. In a case where the user is “host computer,” the path is assigned to the host computer, and thus, the logical unit is recognizable to the host computer.

A type (“real” or “virtual”) of logical unit is written in the logical unit type T640. For example, an administrator or the like estimates the necessary capacity, and the capacity is fixed to the logical unit according to the estimated capacity. This type of the logical unit is “real”. In other words, in a case of the real logical unit, the physical resource having the necessary capacity is allocated when the logical unit is generated. Namely, the logical unit shown in the first embodiment is a real logical unit.

Meanwhile, as shown in the second embodiment, the type of the logical unit to which the segment is allocated according to the access request from the host computer, and of which real capacity is dynamically extended according to the allocated segment is “virtual”. Namely, the logical unit shown in the second embodiment is a virtual logical unit.

Note that, the identifiers written in the logical unit name T600 may be a symbol or a character string which can be uniquely identified other than a number. In addition, the values of the logical unit name T600, the user T630 and the logical unit type T640 may be replaced with an appropriate number, symbol or character string.

<3-2 Process>

In the computer system in the third embodiment, the process of a logical unit task history search program 5140 is the same process as the logical unit task history search program 5140 in the first embodiment shown in FIG. 5.

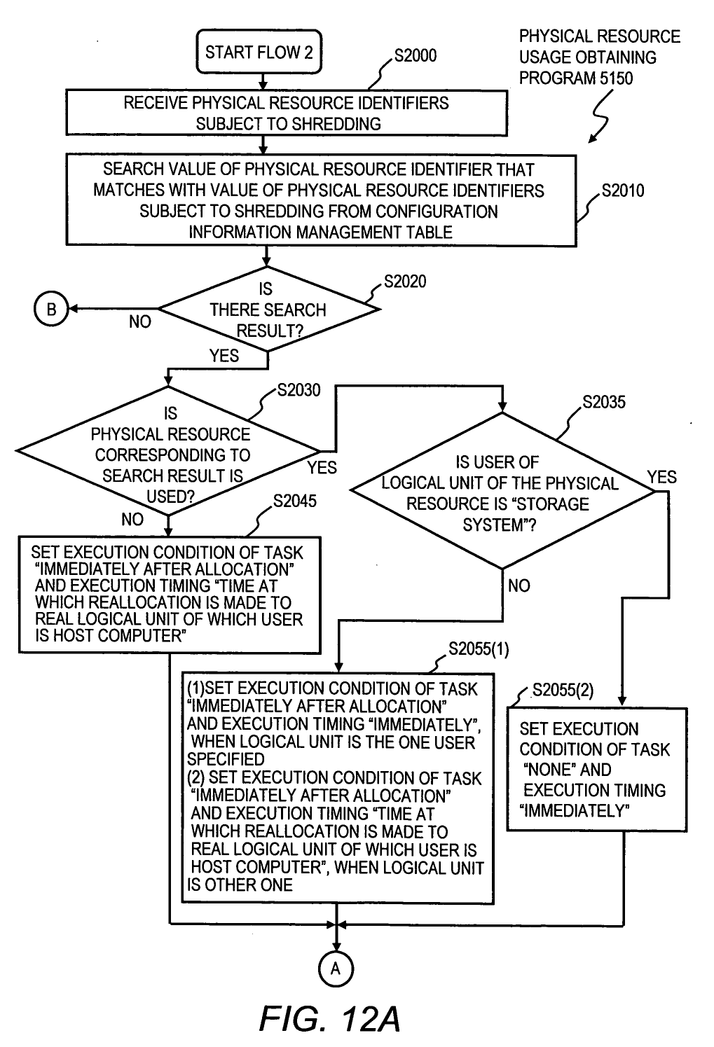

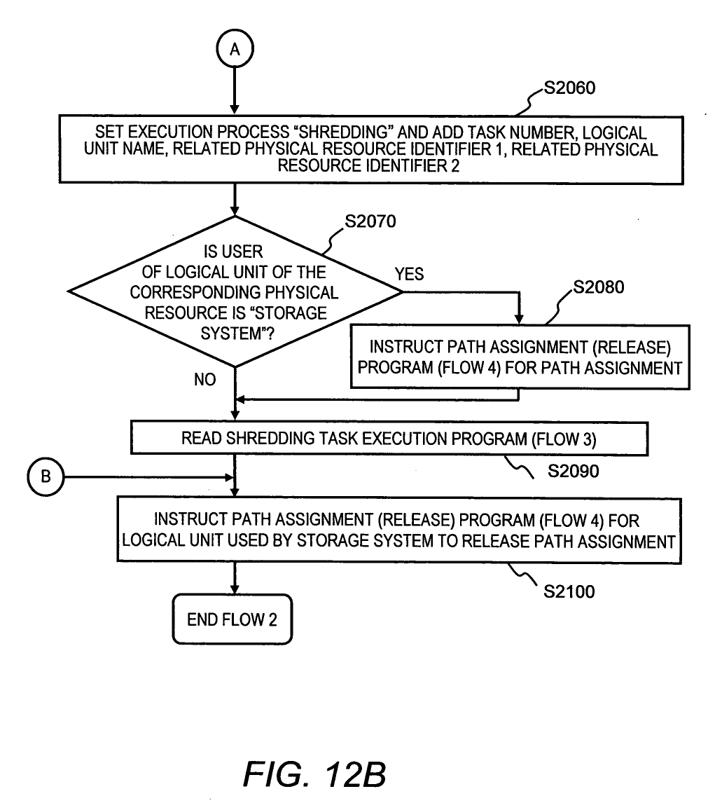

FIGS. 12A and 12B are a flowchart for showing a physical resource usage obtaining program 5150 according to the third embodiment of this invention.

The process from Step S2000 to Step S2030 shown in FIG. 12A is the same process as FIG. 6.

In Step S2030, in a case where it is judged that the physical resource selected to be shredded is not currently allocated to the logical unit to which the host computer 2000 or the storage system 1000 makes an access, the physical resource usage obtaining program 5150 adds a new entry to a task management table 5125. In the newly added entry, the execution condition T550 and the execution timing T560 of the physical resource selected to be shredded are set to “immediately after allocation” and “the user is the host computer and the timing is set to the time of allocation to the logical unit of which logical unit type is “real,” respectively (S2045).

Here, “immediately after allocation” means that the shredding is performed immediately after the allocation to the real logical unit.

The execution timing T560 is set to the time of allocation to the logical unit because the physical resource which is not allocated to the logical unit cannot be recognized by the host computer 2000 so that the host computer 2000 cannot perform the shredding process.

Moreover, in the execution timing T560, the user of the logical unit of the allocation destination is the host computer 2000 because the logical unit can be recognized by the host computer which stores the shredding program (in a case where the user is “storage system,” the host computer 2000 cannot recognize the logical unit.)

In addition, the logical unit type of the allocation destination is set to “real” because the host computer 2000 can only recognize the logical unit of the storage system 1000 but cannot recognize the physical resource allocated to the logical unit. In this embodiment, since the host computer 2000 performs the shredding process, the shredding process is performed on the logical unit. Even in a case where the virtual logical unit using the thin provisioning, the logical unit recognized by the host computer 2000 is shredded. In other words, the shredding process is performed not only on the physical resource allocated to the virtual logical unit but on the other physical resource according to a write process of dummy data at the time of shredding. Accordingly, in this embodiment, the execution timing T560 is set to the time at which the physical resource is allocated to “real” logical unit.

Meanwhile, in Step S2030, the physical resource selected to be shredded is judged to be used, judgment is made whether the user of the logical unit to which the physical resource is allocated is “storage system” (S2035).

In a case where it is judged that the user is not “storage system”, namely, the user is “host computer”, judgment is made whether the physical resource selected to be shredded is currently allocated to the logical unit specified by the user in Step S1000.

In a case where the physical resource selected to be shredded is judged to be currently allocated to the logical unit specified by the user in Step S1000 (in a case of (1) of S2055(1)), the physical resource usage obtaining program 5150 adds a new entry to the task management table 5125 and sets the execution condition T550 and the execution timing T560 of the physical resource selected to be shredded to be “none” and “immediately”, respectively. The value “none” in the execution condition means that the execution condition is not set and a task can be performed as long as the execution timing is satisfied.

In a case where the physical resource selected to be shredded is judged to be allocated to the logical unit other than the logical unit specified by the user in Step S1000 (in a case of (2) of S2055(1)), the physical resource usage obtaining program 5150 adds a new entry to the task management table 5125. In the newly added entry, the execution condition T550 and the execution timing T560 of the physical resource selected to be shredded are set to “immediately after allocation” and “the user is the host computer and the timing is set to the time of reallocation to the logical unit of which logical unit type is “real,” respectively (S2055 (1)).

Here, “immediately after allocation” means that the shredding is performed immediately after the allocation to the real logical unit.

The user of the logical unit reallocated to the physical resource is set to “host computer” and the logical unit type is set to “real” as the case of Step S2045.

Moreover, the shredding process is performed on the logical unit to which the physical resource is reallocated but not on the logical unit to which the physical resource is currently allocated because other data may be written to the logical unit to which the physical resource is currently allocated. Consequently, the data is prevented from mistakenly erasing.

In a case where the user is judged to be “storage system”, the physical resource usage obtaining program 5150 adds a new entry to the task management table 5125. In the newly added entry, the execution condition T550 and the execution timing T560 of the physical resource selected to be shredded are set to “none” and “immediately,” respectively (S2055 (2)).

Here, the execution timing is set to “immediately” because in a case where the user is “storage system,” the storage system 1000 is holding the logical unit as the migration destination and other data is not stored, and thus, even though the task is executed “immediately”, the other data is not erased. Note that, the value “none” in the execution condition means that the execution condition is not set and a task can be performed as long as the execution timing is satisfied.

The process of Step S2060 is the same process as shown in FIG. 6.

After Step S2060, the physical resource usage obtaining program 5150 refers to the configuration information management table 5135 shown in FIG. 11 and judges whether the user of the identifier of the physical resource selected in Step S2030 is “storage system” (S2070).

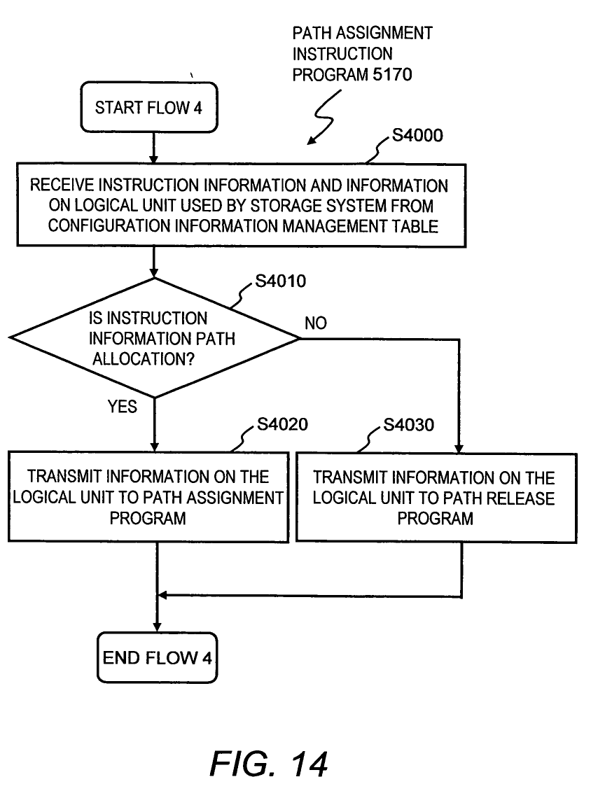

In Step S2070, the user of the logical unit allocated to the physical resource is judged to be “storage system”, the physical resource usage obtaining program 5150 proceeds the process to Step S2080. The physical resource usage obtaining program 5150 instructs the path assignment (release) instruction program 5170 to assign a path to the host computer 2000 from the logical unit to which a path is not assigned to the host computer 2000, and which is held to be used by the storage system 1000. The path assignment (release) instruction program 5170 issues a path assignment instruction to the path assignment program1213 stored in the main memory 1210 in the storage system 1000 (S2080). The process proceeds to Step S2090. The path assignment program1213 which received the path assignment instruction performs the path assignment to make the logical unit specified by the host computer recognizable according to the instruction. Note that, the process of the path assignment (release) instruction program 5170 will be described in detail later with reference to FIG. 14.

Meanwhile, in Step S2070, in a case where it is judged that the user of the logical unit to which the physical resource is allocated is not “storage system”, the host computer 2000 can recognize the logical unit, the physical resource usage obtaining program 5150 proceeds the process to Step S2090.

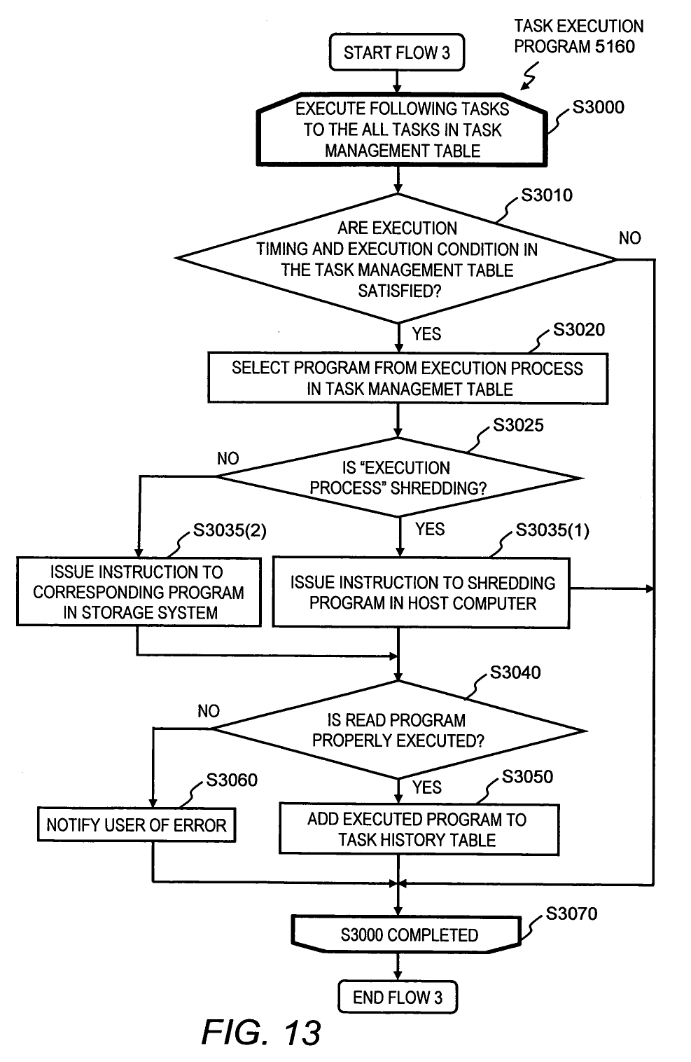

Subsequently, the physical resource usage obtaining program 5150 reads the task execution program 5160 (S2090). Note that, the process of the task execution program 5160 will be described in detail later with reference to FIG. 13.

Lastly, the physical resource usage obtaining program 5150 transmits a path assignment release instruction to the path assignment (release) instruction program 5170 for the logical unit to which the path is assigned in Step S2080, and which “user” is the storage system 1000 (S2100). The path assignment (release) instruction program 5170 transmits an instruction to the path release program1214 stored in the main memory 1210 in the storage system 1000. However, in a case where the process of path assignment is not necessary in Step S2080, the process of path assignment release is omitted in Step S2100. The path release program1214 makes the logical unit specified by the host computer unrecognizable (path assignment release) according to the instruction.

The physical resource usage obtaining program 5150 then completes the process.

FIG. 13 is a flowchart for showing a task execution program 5160 according to the third embodiment of this invention.

The process of Step S3000 to Step S3020 shown in FIG. 13 is the same process as shown in FIG. 7.

After Step S3020, the task execution program 5160 judges whether the selected execution process is “shredding” (S3025).

Next, in a case where the task execution program 5160 judges that the execution process is “shredding” in S3025, the task execution program 5160 issues an execution instruction to the shredding program 2110 in the host computer 2000 through the management network 4000 (S3035 (1)).

More specifically, the logical unit to which the physical resource subject to shredding is allocated is identified based on the configuration management information, and the logical unit name is notified to the host computer. Here, the host computer 2000 can recognize the logical unit but cannot recognize the physical resource allocated to the logical unit. Accordingly, the identifier of the related physical resource is not notified.

The shredding program 2110 in the host computer 2000 which received the instruction performs the shredding process on the notified logical unit.

Meanwhile, in a case where the task execution program 5160 judged the execution process is not “shredding” in Step S3025, the task execution program 5160 issues an execution instruction to the corresponding program in the storage system through the management network 4000 (S3035 (2)).

For example, in a case where the execution instruction is for migration, the migration program 1212 is notified of the logical unit name and/or the related physical resource identifier 1 and the related physical resource identifier 2 to be migrated. Subsequently, the migration program 1212 performs the migration process between the related physical resource identifier 1 and the related physical resource identifier 2 of the notified logical unit name of the logical unit.

The process Step S3040 and Step S3070 is the same process as shown in FIG. 7.

FIG. 14 is a flowchart for showing a path assignment (release) instruction program 5170 according to the third embodiment of this invention.

The path assignment (release) instruction program 5170 obtains information on the logical unit which is used by the storage system 1000 from the configuration information management table 5130. In addition, in Step S2080, the path assignment (release) instruction program 5170 receives the instruction information (the path assignment instruction or the path assignment release instruction) transmitted from the physical resource usage obtaining program 5150 (S4000).

Subsequently, the path assignment (release) instruction program 5170 judges whether the transmitted instruction information is path assignment (S4010). In Step S4010, in a case where the instruction information is path assignment, the path assignment (release) instruction program 5170 instructs the path assignment program1213 stored in the main memory 1210 in the storage system 1000 to assign the path (S4020). The path assignment program1213 assigns the path of the logical unit which is used by the storage system 1000 to the host computer 2000 according to the path assignment instruction. Consequently, the shredding program 2120 stored in the main memory 1210 in the host computer 2000 can perform shredding on the physical resource allocated to the logical unit.

Meanwhile, in Step S4010, in a case where it is judged that the instruction information is not path assignment but is path assignment release, the path assignment (release) instruction program 5170 issues the path assignment release instruction to the path release program1214 stored in the main memory 1210 in the storage system 1000. The path release program1214 releases the path of the logical unit allocated to the host computer 2000 according to the path assignment release instruction transmitted from the path assignment (release) instruction program 5170 (S4030).

Note that, in a case where the path assignment program1213 and the path release program1214 are stored in the management computer 5000, the management computer 5000 performs path assignment and path assignment release by executing the path assignment program1213 and the path release program1214 without instructing the storage system 1000 to perform path assignment and path release.

As described above, according to the third embodiment, the computer system judges whether shredding can be performed from the host computer on the all physical resources which have been allocated to the logical unit specified by the user before according to the type of the logical unit. Accordingly, the computer system can perform an appropriate task for each physical resource.

### INDUSTRIAL APPLICABILITY

As described above, this invention can be applied to a computer system which provides physical resources of a disc device to a host computer. This invention can be also applied to a virtual computer system which provides a plurality of virtual computers.

While the present invention has been described in detail and pictorially in the accompanying drawings, the present invention is not limited to such detail but covers various obvious modifications and equivalent arrangements, which fall within the purview of the appended claims.

What is claimed is:

1. A computer system comprising:
a storage system which includes a storage device for providing a plurality of physical resources allocated to a plurality of logical units, a first processor and a first memory coupled to the first processor; and
a management computer which manages the storage system, and which includes a second processor and a second memory coupled to the second processor, which stores first allocation information and second allocation information, the first allocation information including relation between the plurality of logical units and the plurality of physical resources that has been allocated to the plurality of logical units before, and the second allocation information including relation between the plurality of logical units and the plurality of physical resources that is currently allocated to the plurality of logical units,
wherein the management computer is configured to:
identify a first physical resource which has been allocated before to a first logical unit specified for data erasing based on the first allocation information; and
identify a second physical resource which is currently allocated to the first logical unit based on the second allocation information, and
wherein the storage system is configured to write data for data erasing into the identified first physical resource and the identified second physical resource.

2. The computer system according to claim 1,
wherein the second memory stores a data erasing program,
wherein the management computer is further configured to transmit a data erasing instruction for the first physical resource and the second physical resource to the storage system, and
wherein the second processor is configured to write data for data erasing into the first physical resource and the second physical resource using the data erasing program stored in the second memory according to the data erasing instruction.

3. The computer system according to claim 2,
wherein the management computer is further configured to:
judge whether the first physical resource is currently allocated to the second logical unit which is included in the plurality of logical units; and
transmit the data erasing instruction for the first physical resource to the storage system in a case where the first physical resource is not currently allocated to the second logical unit.

4. The computer system according to claim 3,
wherein the management computer is further configured to transmit the data erasing instruction for the first physical resource to the storage system after the allocation of the first physical resource is released from the second logical unit, in a case where the first physical resource is currently allocated to the second logical unit.

5. The computer system according to claim 1 further comprising:
a host computer including a third processor which transmits a read request and a write request of data to the storage system, and a third memory coupled to the third processor, which stores a data erasing program,
wherein the management computer is further configured to:
judge whether the first physical resource is currently allocated to a second logical unit which is included in the plurality of logical units;
transmit a data erasing instruction for the another logical unit to the host computer in a case where the first physical resource is judged to be currently allocated to the second logical unit in a case where the first physical resource is reallocated to another logical unit which is included in the plurality of logical units; and
instruct the storage system to cause the third processor to write data for data erasing into the another logical unit using a data erasing program stored in the third memory according to the data erasing instruction.

6. The computer system according to claim 5,
wherein the management computer is further configured to:
transmit the data erasing instruction for the first logical unit to the host computer; and
instruct the storage system to cause the third processor to write the data for data erasing into the first logical unit using the data erasing program stored in the third memory according to the data erasing instruction.

7. The computer system according to claim 5,
wherein the management computer is further configured to:
transmit the data erasing instruction for the logical unit to which the first physical resource is allocated, to the host computer after the first physical resource is allocated to any one of the plurality of logical units, in a case where the first physical resource is not currently allocated to any one of the plurality of logical units; and
instruct the storage system to cause the third processor to write the data for data erasing into the logical unit to which the first physical resource is allocated using the data erasing program stored in the third memory according to the data erasing instruction.

8. The computer system according to claim 5,
wherein, in a case where the second physical resource is currently allocated to a third logical unit which is held to be used by the storage system, and which is included in the plurality of logical units, the management computer is further configured to:
issue an instruction to the storage system to make the third logical unit recognizable to the host computer;
transmit the data erasing instruction for the third logical unit to the host computer; and
instruct the storage system to cause the third processor to write the data for data erasing into the third logical unit using the data erasing program stored in the third memory according to the data erasing instruction.

9. The computer system according to claim 7,
wherein the first processor is further configured to:
allocate a physical resource which is included in the plurality of physical resources to a virtual logical unit which is included in the plurality of logical units in a case of receiving a write request from the host computer; and
prohibit the storage system from causing the third processor to write data for data erasing into the virtual logical unit using the data erasing program stored in the third memory according to the data erasing instruction in a case where the logical unit to which the first physical resource is allocated is the virtual logical unit.

10. The computer system according to claim 1,
wherein the management computer is further configured to identify a physical resource into which the data for data erasing is already written between the first physical resource and the second physical resource, and
wherein the storage system is further configured to prevent to write the data for data erasing into the identified physical resource.

11. The computer system according to claim 1, wherein the first physical resource is a migration source of data to be stored in the second physical resource.

12. A data erasing method which is executed in a computer system, the computer system comprising:
a storage system which includes a storage device for providing a plurality of physical resources allocated to a plurality of logical units, a first processor and a first memory coupled to the first processor; and
a management computer which manages the storage system, and which includes a second processor and a second memory coupled to the second processor, which stores first allocation information and second allocation information, first allocation information including relation between the plurality of logical units and the plurality of physical resources that has been allocated to the plurality of logical units before, and the second allocation information including relation between the plurality of logical units and at least one of the plurality of physical resources that is currently allocated to the plurality of logical units,
the data erasing method including the steps of:
identifying, by the management computer, a first physical resource which has been allocated before to a first logical unit specified for data erasing based on the first allocation information;
identifying, by the management computer, a second physical resource which is currently allocated to the first logical unit based on the second allocation information; and
writing, by the storage system, data for data erasing into the identified first physical resource and the identified second physical resource.

13. The data erasing method according to claim 12,
wherein the second memory stores a data erasing program, and
wherein the data erasing method further includes the steps of:
transmitting, by the management computer, a data erasing instruction for the first physical resource and the second physical resource to the storage system; and
writing, by the second processor, data for data erasing into the first physical resource and the second physical resource using the data erasing program stored in the second memory according to the data erasing instruction.

14. The data erasing method according to claim 13,
wherein the data erasing method further includes the steps of:
judging, by the management computer, whether the first physical resource is currently allocated to the second logical unit which is included in the plurality of logical units; and
transmitting, by the management computer, the data erasing instruction for the first physical resource to the storage system in a case where the first physical resource is not currently allocated to the second logical unit.

15. The data erasing method according to claim 14,
wherein the data erasing method further includes the step of:
transmitting, by the management computer, the data erasing instruction for the first physical resource to the storage system after the allocation of the first physical resource is released from the second logical unit in a case where the first physical resource is currently allocated to the second logical unit.
